(19) United States
(12) Patent Application Publication
(10) Pub. No.: US 2016/0031206 A1
(43) Pub. Date: Feb. 4, 2016

(54) PRINTING PLATEN AND METHOD FOR USING THE SAME

(71) Applicant: John Budd, Orange, CA (US)

(72) Inventor: John Budd, Orange, CA (US)

(21) Appl. No.: 14/447,358

(22) Filed: Jul. 30, 2014

(51) Int. Cl. B41F 17/00

(52) U.S. Cl. CPC B41F 17/005

(57) ABSTRACT

The present disclosure relates to a platen and process for using the platen for treating irregularly shaped textile such as a shoe upper. Platens disclosed herein can include a substantially flat platen comprising a base portion, an extension off the base portion, and a tip connected to the extension, in which all the respective components generally occupying a single plane. The base portion that includes at least one groove has a generally elongated shape with a distal end, a proximal end. The tip is configured to support one or more cords to apply tension to a textile. The platen also includes a securing member used to secure an edge of the textile to the base portion of the platen. The securing member can include protrusions running along one or both bottom edges to help secure the edge of a textile with the grooves.

### BACKGROUND OF THE INVENTION

1. Field of the Invention

The present disclosure relates to a platen used to secure and flatten an irregularly shaped textile, such as the upper part of a shoe, so that a treatment can be applied to the textile, such as the application of one or more paints or inks.

2. Description of the Related Art

In a fabric printing process, unlike printing onto paper or the like, it is difficult to secure and flatten the fabric or textile onto a surface or support structure. Creases caused by irregularities (e.g., wrinkles, seams, other materials such as rivets, eyelets, etc.) in the surface are liable to occur, and achieving sufficient flatness of the textile is extremely difficult to achieve. If the textile cannot be held flat on the platen, then the accuracy of printing by emitting ink will decline, and depending on the circumstances, situations may occur in which the ink emission heads actually make contact with the fabric. This problem is further complicated when using textiles having irregular shapes.

It is often desirable to apply treatments to any number of different textiles even textiles that have already been cut and formed into a finished or nearly finished product, particularly products having a generally cylindrical shape or configuration such as the upper portion of a shoe. Such a textile is difficult to treat especially if the treatment is a printing process because, as discussed above, a printing process generally requires a flat surface. Thus, textiles that have been formed into a finished or nearly finished product are problematic in that they may contain various surface irregularities, curves, distinct materials (distinct textile materials or non-textile materials), etc. Moreover, in the case of textiles like shoe uppers, there may be a desire to treat all of the exterior surface of the textile but flattening the textile, even if possible, generally allows for treating only one side of the flattened textile.

### SUMMARY OF THE INVENTION

The present disclosure relates to a platen that may be substantially flat for securing a textile such as a shoe upper to be treated with a process such the application of one or more paints. The platen may include an elongate base portion occupying a plane, the base portion having a distal end and a proximal end, the distal and proximal ends being separated along a first axis extending lengthwise. The base portion is configured to engage a mounting base. The platen can also include an extension occupying substantially the same plane as the base portion where the extension extends from the base portion generally along a second axis, the second axis being generally orthogonal to the first axis. The extension can also be configured to engage a mounting base.

Some embodiments of a platen can also include a strap configured to secure a tip portion of the textile to a point along the base portion of the platen toward the proximal end. The strap can apply pressure to the tip portion on both the top and bottom surfaces of the textile. In some embodiments, the extension is configured to pass through an opening in the textile to secure at least a portion of the textile to the base portion using the strap or other possible securing mechanisms such as a center plate or securing member that attaches or secures to the base portion along its length. Whatever means are used to secure the textile to the platen, a substantially flat surface is achieved on the textile, preferably on both the top and bottom sides of the textile. The strap can be configured to apply pressure to the textile by using at least one of or a combination of the following: magnets, clips, clamps, bolts, pins, straps, and adhesive tape.

In some embodiments, the platen can also include one or more grooves running substantially the length of the base portion. Such grooves can be designed to receive an edge of the textile or an irregularity attached to the textile, the grooves extending generally parallel to the first axis.

Some platen embodiments include a tip located at the end of the extension or one tip at each extension. In some embodiments, the tip lies in substantially the same plane as both the base portion and the extension(s), and the tip extends from the outermost part of the extension(s) in a direction generally parallel to the base portion and, in some embodiments, orthogonal to the extension(s).

Some embodiments include a securing member or plate configured to hold or secure a first edge of the textile or an irregularity attached to the textile to the base portion. In some embodiments, the securing plate does this by clamping down on the edge, often holding the edge or a zipper along the edge in a groove running along the base portion. The securing plate can include protrusions along an edge of a surface, the protrusions configured to help secure the first edge of the textile within the at least one groove. In some cases, the securing member holds on to a zipper, though it can also be configured to simply hold a portion of the textile that is thicker than the rest of the textile. Some embodiments include two securing members or plates where one plate is positioned on the top of the platen, and the other plate is positioned on the bottom. In some embodiments, the two platens are secured to each other, and in some embodiments they are independently secured to the platen. Moreover, an edge of the securing member can form a curve to match a curve in the edge of the textile.

According to some embodiments, the base portion of the platen, wherein the base portion includes a magnetic material that can be embedded within the base portion or affixed thereon. The securing member can also be made of or include a magnetic material so that it is held at least partially in place against the base portion by a magnetic force. In some embodiments, the base portion includes a depression running the length of the platen. A magnetic material may be placed in the groove so that a top surface of the magnetic material lies in the same plane as the rest of the base portion, extension, etc. And, in some embodiments, the orientation of the magnetic material within the depression may create the groove described above. However, the depression and groove need not be structurally related in this manner.

According to some embodiments of the present disclosure, the extension(s) of a platen comprises two edges: a first edge along the distal end of the platen and a second edge facing the proximal end of the platen. Either edge may form a curve that corresponds to the shape of the textile.

In some embodiments, one or more connectors are used to secure and/or smooth or flatten the textile. The connectors, with one end secured to a tip of the platen, can be attached along an edge of the textile, in some cases utilizing eyelets or holes in the textile. The connectors can be made of at least one of or a combination of the following: an elastic material, a strap comprising a hook-and-loop attachment mechanism, a strap comprising a buckle, a strap comprising a cam buckle, and an adhesive tape.

According to some embodiments, a platen can include two extensions and, in some cases, two tips arranged opposite each other on either side of the base portion. This allows two separate textiles to be secured to the platen so that the same process can be applied to the two textiles at the same time, not only saving time and money, but also perhaps allowing for identical patterns or mirror patterns that otherwise would be difficult or impossible to produce.

Also disclosed herein is a method of treating an irregularly shaped textile, in which the method utilizes a platen having the characteristics and features disclosed herein. With such a platen, a textile is first slipped over an extension. In some embodiments, the textile can be pulled tight and secured using a toe strap. In some embodiments, a securing member is first used to secure an edge of the textile to the base portion of the platen before the toe strap is secured in place. In some embodiments, additional tension is applied to the textile using connectors attached between another edge of the textile and a tip on the extension of the platen. Once secured, the platen can be mounted onto a base in order to receive a treatment process such as the application of a paint. The platen can then be removed from the base, turned over, and remounted to the base so that the other side of the textile can receive the same or a different treatment.

### BRIEF DESCRIPTION OF THE DRAWINGS

FIG. 1 illustrates an embodiment of a platen used to support a textile for printing.

FIG. 2 illustrates an embodiment of a platen onto which a textile is being positioned for printing.

FIG. 3 illustrates an embodiment of a platen with two textiles affixed to the platen for printing.

FIG. 4 illustrates a mounting base configured to receive a platen.

### DETAILED DESCRIPTION OF THE PREFERRED EMBODIMENT

Disclosed herein are various embodiments of both a platen for printing on a textile or otherwise applying a process to a textile as well as a method for using such a platen. Thus, it should be understood that the platens disclosed may be used with a variety of processes even if such processes are not fully disclosed herein. Similarly, the methods disclosed encompass the use of a variety of platen embodiments even though such embodiments may not be fully disclosed herein.

According to some embodiments, a platen for applying ink to a textile comprises a support structure configured to both adequately flatten the textile to facilitate the application of one or more inks to the textile and allow for the treatment—simultaneous and/or sequential—of both flattened faces of the textile. In particular, some embodiments of a platen are designed to hold or support an upper portion of a shoe that has been separated from or has not yet been attached to a sole portion. In some embodiments, the shape of the platen is determined by the shape of the shoe upper that is used.

According to the present disclosure, a number of distinct structures are disclosed including, but not limited to, platens, center plates, fasteners (physical, adhesive, etc.), straps, hooks, eyelet covers, and mounting base. The materials used for each structure may be the same or different and may comprise metals, plastics, polymers, woods, graphite, or combinations thereof. The exact material or materials used for each structure may depend on the structure. For example, in some embodiments a wooden platen may be used with a metal mounting base, metal fasteners, metal center plate, metal strips, metal hooks, and plastic eyelet covers. However, other variations could be used as well. In some embodiments, magnets may also be used either in place of other materials or in combination with other materials. For example, some embodiments utilize a wooden superstructure with magnets imbedded within the platen or affixed to a surface of the platen.

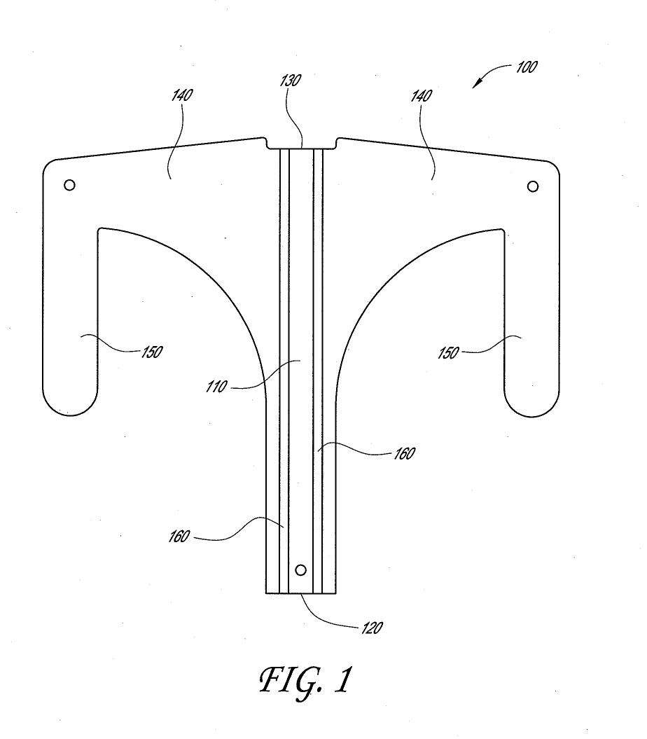

FIG. 1 illustrates an embodiment of a platen 100 for use with a shoe upper. The platen of this embodiment comprises a base portion 110 having a proximal end 120 and a distal end 130. The proximal end 120 and distal end 130 run along a first axis that runs the length of the platen 100. In addition to the first axis, the platen 100 can be said to have a second axis that is generally orthogonal to the first axis. Extensions or support arms 140 extend laterally from a center line generally along the second axis of the platen 100, and each support arm 140 has a tip 150 extending toward the proximal end 120 of the platen 100. Alternatively, it could be said that the platen 100 defines a first axis while the extensions 140 define a second axis, in which the second axis is generally orthogonal to the first axis, though it need not be orthogonal. Additionally, the tip 150 can be said to extend from the second axis generally orthogonal thereto so as to run be generally parallel to the first axis. Each support arm 140 is used to hold a separate textile piece such as an upper portion of a shoe. It will be understood that in some embodiments of a platen according to the present disclosure, only one support arm is used.

In some embodiments, the base portion 110 may comprise an elongated central structure able to support two separate extensions or support arms for attaching two separate textiles to a platen. For example, in some embodiments in which the textile is the upper or textile part of a shoe, two such shoe uppers can be attached to the platen. However, in some embodiments, the base portion may be oriented to the side of a single extension that is configured to secure only a single textile.

According to some embodiments, a substantial portion of the platen 100 will be flat, i.e., lie in a single plane. In some embodiments every portion of the platen occupies the same plane and is substantially flat. However, in some embodiments a portion of the platen 100 may be raised or indented as desired to accommodate irregularities in the textile that is used. Examples of irregularities include, but are not limited to, zippers, rivets, eyelets, seams, folds, beads, buttons, hems, multiple-layered areas, materials other than the textile material that are thicker or thinner than the textile material, etc.

In some embodiments of the present disclosure, the platen 100 includes a groove 160 extending along the length of the base portion 110. In some embodiments, more than one groove may be used along the length of the middle support or base portion 110. For example, in some embodiments, more than one shoe upper may be affixed to or supported by the platen 100, in which case the base portion or middle support 110 will comprise grooves 160 along both lateral edges, the grooves 160 running generally parallel to the first axis of the middle support 110. In some embodiments, the path of one or more of the grooves 160 comprises a straight line extending along the middle support or base portion 110, and in some embodiments, the path of the groove is adjusted or patterned to match any particular irregularities exhibited by the textile used. For example in some embodiments, the path of the groove 160 roughly corresponds to a zipper attached to a bottom portion of a shoe upper. The groove 160 facilitates the flattening of a textile onto the platen 100 by creating a space into which a zipper or other irregularity is accommodated.

In some embodiments, it may be desirable to affix a metal or magnetic plate along a center line of the platen 100 running from the distal end 130 to the proximal end 140. In some embodiments, this is done by incorporating a singe wide groove or depression down a centerline of the platen 100 to accommodate the thickness of the metal or magnetic plate as well as any surface irregularities of the textile. In some embodiments, the one or more grooves can be created and thickness of metal or magnetic plate can be accommodated by including a depression running down a centerline, wherein depth of the depression substantially corresponds to the thickness of the metal or magnetic plate, and the width of the depression is greater than the width of the metal or magnetic plate so as to create a gap between the metal or magnetic plate and the rest of the plane that defines the top surface of the platen 100. In some embodiments, one or more magnets are embedded within the platen 100 and can form an edge of the one or more grooves 160. In some embodiments, the depression may comprise a structure independent of the grooves 160.

In some embodiments according to the present disclosure, a metal or magnetic plate located in a center groove of the platen 100 includes protrusions alone each edge of the plate. Such protrusions can help grip or maintain tension on a textile placed on the platen 100. As will be discussed in greater detail below, another metal or magnetic plate (also referred to as a securing member) also having protrusions can be placed over the textile and matched with the plate located in the depression. In such cases, it may be desirable to match or alternate the protrusions of the two plates.

According to some embodiments of the present invention, both the top and bottom surfaces of the platen 100 will comprise the features disclosed herein. Such a configuration facilitates a printing process applied identically to both sides (either simultaneously or sequentially) of a shoe upper or other textile affixed to the platen 100. However, in some embodiments, the top and bottom surfaces may comprise distinct elements. Such configurations may be desirable to achieve different printing patters to each side of a shoe upper or to subject a shoe upper to different process, printing or otherwise.

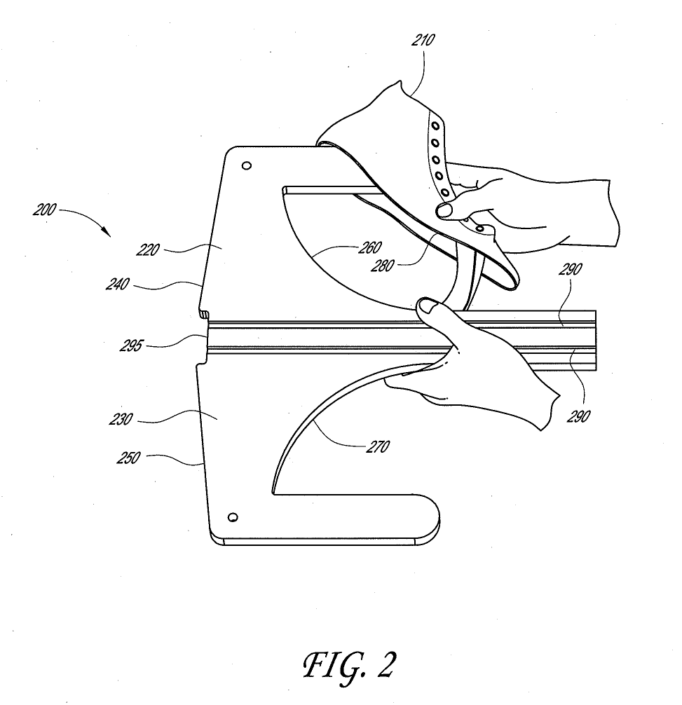

FIG. 2 illustrates an embodiment of a platen 200 onto which a shoe upper 210 is being positioned in order to be secured to the platen 200. As illustrated, some embodiments of the platen 200 are shaped to accommodate the shape of the shoe upper 210. Depending on the shape of the shoe upper or other textile, such accommodation may entail modifying the curvature of the extensions or support arms 220 and/or 230.

For example, in some embodiments in which the textile in question comprises a shoe upper in which the shoe upper comprises a number of curved surfaces, distal edges of support arms 220 and 230 comprise, respectively, curvatures 240 and 250 that substantially conform to or match the curvature of the back portion of the shoe upper 210. In some embodiments the curvatures 240 and 250 are the same; however, in some embodiments it may be desirable for each support arm to exhibit a different curvature particularly if different shoe uppers having distinct profiles are being affixed to the respective support arms 220 and 230 of the platen 200.

As with the curvature 240 and 250, respectively, of the distal portion of support arms 220 and 230, the respective proximal edges of each support arm can be configured with second curvatures 260 and 270 or other suitable shapes that conform to the shape of the textile being affixed to the platen 200. In some embodiments, for example, the second curvatures 260 and 270 comprise curves generally corresponding to the front or top portion of the shoe upper. In some embodiments, it is desirable for the second curvatures 260 and 270 to substantially correspond to the shoe upper 210 such that when affixed, substantially all of the shoe upper is supported underneath by the platen 200. In other words, the top surface of the platen 200 fully supports the textile material. In some embodiments, however, the curvature or pattern of the support arms 220 or 230 need not exactly correspond to or even substantially correspond to the curvature of the shoe upper 210. As will be explained in greater detail below, the textile being affixed to the platen 200 can be held in place using a number of suitable methods including, but not limited to, applying tension to the textile to create a smooth, flat top surface.

According to some embodiments of the present disclosure, a method of affixing a textile or fabric to a platen comprises a number of steps. Where the textile comprises the upper portion of a shoe, the shoe upper 210 is slid over one of support arms 220 or 230. Once the shoe upper 210 is slid over one of the support arms 220 or 230, the shoe upper 210 is pulled toward the center of the platen 200 until a zipper 280 or bottom edge of the textile can be matched up with the one or more grooves 290 located near or parallel to a centerline of the platen 200. In some cases, the shoe upper 210 will have attached a “tongue,” in which case the tongue can be pulled down and forward in order to not be treated in the textile treatment process.

In some embodiments, a method of installing a textile onto a platen or affixing a textile onto a platen includes positioning the platen 200 with a distal end 295 away from a user with the proximal portions of the platen 200 toward the user, the platen 200 resting on a flat surface such as a table or even the user's lap. In this position, a user slides the shoe upper 210 over one of the respective support arms 220 or 230. The user can then pull the shoe upper 210 towards her to better flatten it out and fasten it to the platen 200 as required

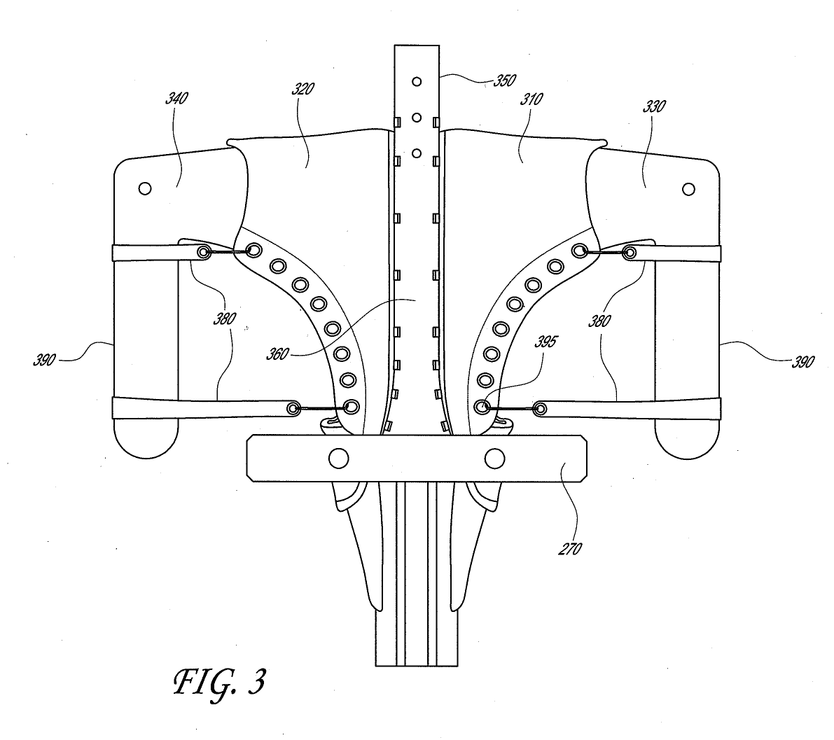

FIG. 3 illustrates an embodiment of a platen 300 onto which shoe uppers 310 and 320 have been pulled down over support arms 330 and 340. In some embodiments, the shoe uppers 310 and 320 are pulled down until a zipper or other irregularity can be matched up to one or more grooves in the platen 300, such as the grooves described above with respect to FIGS. 1 and 2.

According to some embodiments, it is desirable to temporarily affix shoe uppers 310 and 320 to the platen 300 using a physical fastener such as a clip or clamp. According to some embodiments, the fastener is applied toward a distal end of the platen so as to secure respective heel portions of the shoe uppers 310 and 320. If large enough, a single fastener may be used to affix both shoe uppers. However, two or more fasteners may also be used. In some embodiments, two fasteners are used, one each on respective distal portions of extensions or support arms 330 and 340. While fasteners may be applied at positions other than the heel portion, such placement may be advantageous as it allows a user to pull the shoe uppers in a proximal direction while securing other portions of the shoe upper, particularly when the platen 300 is positioned with the distal end 350 pointing away from a user.

FIG. 3 also illustrates a securing mechanism or center plate 360. In some embodiments, the center plate 360 is shaped to match a bottom contour of the respective shoe uppers 310 and 320. Moreover, in some embodiments, the center plate 360 comprises protrusions or grippers on the underside (not shown) that hold a surface irregularity such as a zipper in place to better secure a textile to the platen 300. As mentioned above, the protrusions of the center plate 360 can be configured to correspond to protrusions on a metal or magnetic plate affixed to the platen 300 in a center groove or depression of the platen 300. Corresponding protrusions can be matched or alternating configurations; however, other configurations are also contemplated by the present disclosure.

In some embodiments, the securing mechanism or center plate 360 comprises an elongated, flattened material. In some cases, it comprises a metal that can be attracted to a magnetic force or that produces its own magnetic force. In some embodiments, methods other than or in addition to magnetism are used to secure the mechanism to a platen.

According to some embodiments of the present disclosure, the center plate 360 may be affixed or secured to the platen 300 using magnets or magnetic attraction. In some embodiments, the platen 300 comprises magnets already in place to which the center plate 360, or magnets affixed to the center plate 360, are magnetically attracted. Such magnetic attraction is sufficient to hold a textile such as a shoe upper 310 in place during a printing process or similar process that may be applied to the textile. In some embodiments, one or more magnets are located on or within the platen 300 such that a magnetically attracted metal securing member or center plate—or a center plate with magnets attached or embedded within—is held in place by the magnetic field existing at the surface of the platen 300. As discussed above, some embodiments include a metal or magnetic plate in a wide groove or depression along a centerline of the platen 300, where the metal or magnetic plate provides either the magnetic attraction to adhere a metal center plate 360 to the platen 300 or the metal to which a magnetic center plate 360 can be attracted.

Moreover, in some embodiments, other means and/or mechanisms are used to adhere or affix the center plate 360 to the platen 300. In some embodiments, physical and/or chemical fasteners are used. Suitable fasteners include, but are not limited to, clips, rivets, buttons, hook-and-loop fasteners (e.g. Velcro®), pins, elastics, screws, bolts, straps, clips, etc. Suitable chemical fasteners include, but are not limited to, adhesives, glues, tapes such as double or single sided tapes, etc. Some embodiments using one or more mechanical and/or chemical fasteners also take advantage of magnetic attraction. For example, in some embodiments, magnetic attraction (e.g., between the securing member or center plate 360 and magnets in or on the platen 300 as described herein) is used and initially to position the textile and the center plate 360 while a fastener is then used to securely affix the center plate 360. In other words, the magnetic attraction provides just enough force to hold the various pieces together until another fastener can be put in place. In fact, in some embodiments, the center plate 360 is not even made of a magnetic or even metal material. In such embodiments, it can be desirable to position the center plate 360 over one or more edges of the textile, place one or more magnets on top of the center plate 360 to hold it down—assuming the platen 300 beneath comprises a metal or magnetic material—while one or more other fasteners are applied to the center plate 360. The one or more magnets can then be removed for the printing or treating process.

In some embodiments, the securing member or center plate 360 is affixed to the platen on both a top and bottom surface of the platen 300 so as to secure both sides of shoe uppers 310 and 320 (i.e., top and bottom surfaces relative to a user). In some embodiments using magnetism to hold the center plate 360 in position, either temporarily until other fasteners are put in place or for the duration of the process, another center plate or a similarly shaped plate can be applied to underside of the platen 300 to achieve the requisite or desired magnetic force. In such embodiments, it is not necessary that the platen 300 itself already have a magnetic or metal material.

Once, the center plate 360 has been affixed to both the top and bottom of the platen 300, the one or more fasteners that may have been applied at the heel portion or other portion of the shoe uppers 310 and 320 may be removed. However, it is not necessary to remove the fasteners at this point in the process because, according to some embodiments, they can be removed later.

Also illustrated in FIG. 3 is a toe strap 370 located at a proximal end of the platen 300. As with the center plate 360, the toe strap 370 may comprise a magnetic material or a material comprising magnets so that the toe strap 360 can be matched up with a corresponding toe strap (not shown) on the backside of the platen 300. In some embodiments, magnets are physically separate from the toe strap 370 and its counterpart on the underside of the platen 300. With the toe strap 370 and its counterpart in place, the magnets can be on both sides of the toe straps 370 to hold them in place. In some embodiments, the toe strap 370 and a corresponding toe strap may be affixed to the platen 300 using fasteners such as mechanical and/or chemical fasteners. Examples of suitable fasteners include those disclosed elsewhere herein.

With the securing member or center plate 360 (both top and bottom) in place and either before or after affixing the toe strap 370 (both top and bottom), a strap or cord 380 for applying tension to the shoe uppers 310 and 320. In some embodiments, the cord 380 comprises an elastic material with an attachment means (e.g., hooks, etc.) on one or both ends. Where a hook or other attachment means is used on only one end, the other end may comprise a loop. For example, in some embodiments, the cord 380 comprises an elastic loop that is slipped onto the tip 390 of each support arm 330 and 340 so that the hook can then be inserted through one or more eyelets 395 of the shoe uppers 310 and 320. In some embodiments, a single cord 380 is all that is used for each shoe upper. In some embodiments, a single cord comprises multiple hooks or attachment mechanisms so that a single cord can connect to and apply tension to multiple eyelets in a shoe upper. In some embodiments, multiple cords are used to tension in different or similar directions. However many cords are used, the desired result is to achieve a flat surface on the platen 300 to facilitate a printing process or other suitable process to be applied to the textile or shoe upper.

According to some embodiments of the present disclosure, the cord 380 comprises material in which tension can be applied through manual adjustment of the length of the cord. For example, some embodiments utilize a Velcro® strap. Some embodiments utilize a strap or cord with a mechanism for adjusting the length such as a buckle or spring-loaded mechanism (e.g., cam buckle strap, cord lock, cord fastener, plastic stopper, cord toggle, drawstring clamp, etc.). Some embodiments utilize materials such as elastics that require little or no length adjustment in order to provide tension.

According to some embodiments of the present disclosure, pressure is applied throughout the attachment process disclosed herein so that as different portions of the textile or shoe upper are affixed to a platen, the textile or shoe upper is maintained as flat as possible. Thus, before and after each step described herein, the textile or shoe upper should be pressed as flat as possible. Once the textile or shoe upper has been pressed and secured to achieve a suitably even top and bottom surface, the eyelets 395 are preferably covered so that the printing process or other treatment process does not affect the material of the eyelets. In some embodiments, it may be desirable to apply a printing process to the eyelets that may be the same as or different from the process applied to the textile. If the same, then no eyelet covers are necessary. If different, eyelet covers are necessary to preserve the eyelets for the separate process.

In some embodiments, it is possible to supply enough tension to the textile or shoe uppers 310 and 320 simply by securing the toe portions using the toe strap 370. In other words, the textile is slipped over the support arm 330 or 340 and tension is applied by pulling the textile in the proximal direction. The toe strap 370 can then be applied without the need to use the cord 380. In fact, some embodiments do not even include the tip 390. Those embodiments in which the textile is secured using only the toe strap 370 may also not include the securing member or center plate 360.

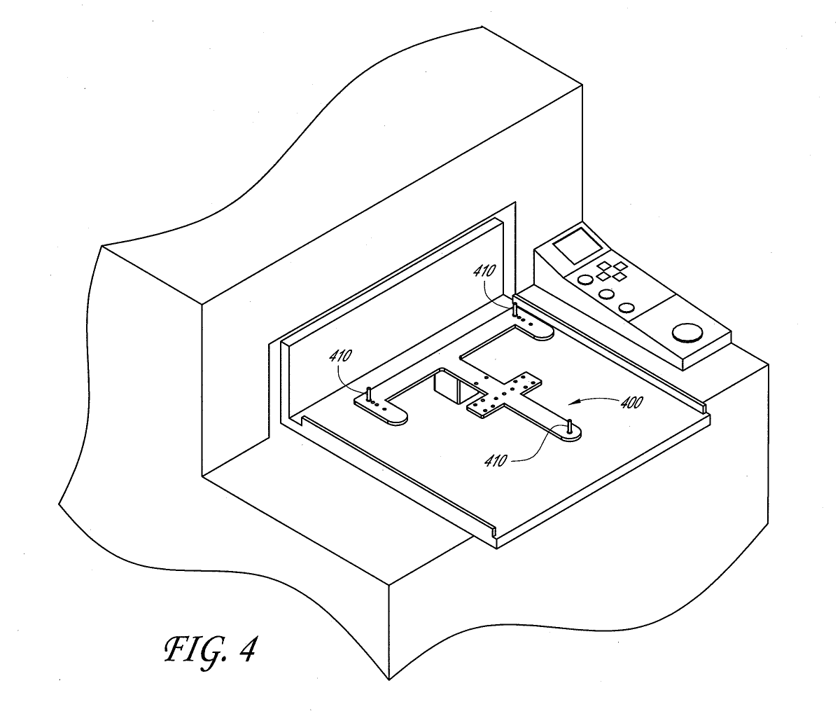

FIG. 4 illustrates an embodiment of a mounting base 400. The general profile of the mounting base of the illustration can roughly correspond to the basic shape of a platen; however, such correspondence is not necessary and other configurations are contemplated by the present disclosure. The mounting base 400 serves to secure a platen during the printing process or any other suitable process that can be applied to a textile or shoe upper attached to a platen. The mounting base 400 may comprise any number of materials so long as the overall structure provides the requisite strength and stability. For example, in some embodiments, the mounting base 400 is comprised of a metal, which in some cases may further comprise a magnetic metal or portions that are magnetic so that a platen—itself magnetic or containing magnetic elements—can be magnetically secured to the mounting base 400. In some embodiments, suitable materials include wood or plastic to which or within magnets can be applied or embedded.

In some embodiments, the mounting base 400 includes mechanical fasteners 410 such as one or more bolts that can be threaded through corresponding holes in a platen. In some embodiments, a mixture of magnets and mechanical fasteners are used. As illustrated in FIG. 4, according some embodiments of the present invention, the mounting base 400 includes mechanical fasteners 410 secured to the mounting base 400. Using this configuration, a platen can be secured so that one side of the platen is subjected to a process (e.g., a printing process), and then the platen can be flipped over and secured in exactly the same position (because the fasteners 410 can be fixed) in order to subject the other side of the platen to the same or a different process (e.g., the same printing process, a printing process of a different pattern or color, or another textile treatment process) Fasteners fixed to the mounting base 410 can include, but are not limited to, bolts, screws, clips, pins, straps, elastics, weights, or any other suitable device of mechanism capable of providing sufficient stability to secure a platen to the mounting base 400.

Once the textile or shoe uppers have been subjected to a suitable process (e.g. a printing process or other textile treatment), a platen and a textile secured thereto can be subjected to a drying process. According to some embodiments of the present disclosure a drying process comprises baking a platen with a textile still secured thereon. In some embodiments, the platen is heated to a sufficient degree and/or for a sufficient time to cure any material applied to the textile. In some embodiments, less heat or time may be used depending on the materials used and/or the desired product characteristics. According to some embodiments, the drying process comprises subjecting a platen to air flow. In some embodiments, a platen is subjected to a drying process and then reattached to a mounting base so that another similar or different treatment can be performed on the textile. This procedure of treatment/drying/treatment can be repeated as many times as required to achieve a desired pattern or a textile having a desired feature or set of features.

Although some embodiments of the invention have been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the scope thereof. Therefore, it is intended that the invention not be limited to the particular embodiments disclosed in the above detailed description, but that the invention will include all embodiments falling within the scope of the appended claims.

What is claimed is:

1. A substantially flat platen for securing a textile to be treated with a process, the platen comprising:
an elongate base portion occupying a plane, the base portion comprising:
a distal end, a proximal end, a first axis, and a second axis, the distal and proximal ends being separated along the first axis extending lengthwise, and the second axis extending widthwise, the second axis substantially orthogonal to the first axis;
the base portion being configured to engage a mounting base;
at least one extension occupying substantially the same plane as the base portion, the at least one extension extending from the base portion generally along the second axis, the at least one extension being configured to engage a mounting base; and
at least one strap configured to secure a tip portion of the textile to a point along the base portion of the platen toward the proximal end, wherein the at least one strap applies a pressure to the tip portion on both the top and bottom surfaces of the textile;
wherein the at least one extension is configured to pass through an opening in the textile to secure at least a portion of the textile to the base portion; and
wherein the at least one strap is configured to allow tension to be applied to the textile to achieve a substantially flat top and bottom surface on the textile to be more easily treated by the process.

2. The platen of claim 1, wherein the base further comprises at least one groove configured to receive an edge of the textile or an irregularity attached to the textile, the groove extending generally parallel to the first axis.

3. The platen of claim 1, further comprising at least one tip occupying substantially the same plane as both the base portion and the at least one extension, the tip extending from the outermost part of the at least one extension taken along the second axis toward the proximal end of the base portion and in a direction generally parallel to the first axis of the base portion.

4. The platen of claim 2, further comprising at least one securing member configured to secure a first edge of the textile or an irregularity attached to the textile to the base portion.

5. The platen of claim 4, wherein the at least one securing member comprises protrusions along an edge of a surface, the protrusions configured to help secure the first edge of the textile within the at least one groove.

6. The platen of claim 5, wherein the at least one securing member and the at least one groove are configured to retain the first edge of the textile, and wherein the first edge is generally thicker than a portion of the textile adjacent to the first edge.

7. The platen of claim 1, wherein the base portion further comprises at least one magnetic material embedded within the base portion or affixed thereon.

8. The platen of claim 7, further comprising at least one magnetic securing member configured to secure a first edge of the textile or an irregularity attached to the textile to the base portion, wherein the at least one magnetic securing member is magnetically attracted to the at least one magnetic material of the base portion.

9. The platen of claim 7, further comprising a depression extending along the first axis from the distal end to the proximal end, the depression configured to receive the at least one magnetic material so that a top surface of the at least one magnetic material lies in substantially the same plane as a top surface of the base portion.

10. The platen of claim 4, wherein the at least one securing member is configured to secure both a top and a bottom surface of the textile.

11. The platen of claim 1, wherein the at least one extension comprises
a first edge extending from about the distal end of the base portion generally along second axis; and
a second edge connecting to the base portion at a point proximal to the distal end,
wherein at least one of the first and second edges comprises a curve that substantially corresponds to at least one edge of the textile.

12. The platen of claim 4, wherein the at least one securing member comprises at least one curved edge that is configured to substantially correspond to a curvature of the first edge of the textile.

13. The platen of claim 3, further comprising one or more connectors, each connector having a first and second end, the first end configured to connect to a second edge of the textile, and the second end configured to attach to the at least one tip.

14. The platen of claim 13, wherein the one or more connectors comprise at least one of or a combination of the following: an elastic material, a strap comprising a hook-and-loop attachment mechanism, a strap comprising a buckle, a strap comprising a cam buckle, and an adhesive tape.

15. The platen of claim 1, wherein the strap applies pressure using at least one of or a combination of the following: magnets, clips, clamps, bolts, pins, straps, and adhesive tape.

16. A method of treating an irregularly shaped textile, the method comprising:
providing a textile to be treated with a process, the textile comprising an opening;
providing a substantially flat platen, the platen comprising:
an elongate base portion occupying a plane, the base portion comprising:
a distal end and a proximal end, a first axis, and a second axis substantially orthogonal to the first axis, the distal and proximal ends being separated along the first axis extending lengthwise;
the base portion being configured to engage a mounting base;
at least one extension occupying substantially the same plane as the base portion, the at least one extension extending from the base portion generally along the second axis, the at least one extension being configured to engage a mounting base; and
at least one strap configured to secure a tip portion of the textile to a point along the base portion of the platen toward the proximal end, wherein the at least one strap is configured to apply pressure to the tip portion on both the top and bottom surfaces of the textile;
inserting the at least one extension through an opening in the textile;
applying tension to the textile to create at least one substantially flat surface on the textile;
securing the textile to the platen by securing the tip portion of the textile between the base portion and the strap;
securing the platen to the mounting, base; and
subjecting a first surface of the textile to a first treatment process.

17. The method of claim. 16, further comprising removing the platen from the mounting base, turning over the platen to expose a second surface of the textile, remounting the platen to the mounting base, and subjecting the second surface to a second treatment process, wherein the first and second treatment process may or may not be the same.

18. The method of claim 16, wherein at least one of the first and second treatment processes comprises a printing process.

19. The method of claim 16, further providing at least one securing member configured to secure to the base portion a first edge of the textile or an irregularity attached to the textile.

20. The method of claim 16, further comprising securing an edge of the textile along the base portion using at least one securing member.

21. The method of claim 16, wherein the strap comprises at least one of or a combination of the following: magnets, clips, elastics, clamps, bolts, pins, straps, and adhesive tape.
